(19) United States
(12) Patent Application Publication
(10) Pub. No.: US 2026/0140300 A1
(43) Pub. Date: May 21, 2026

(54) DISPLAY APPARATUS

(71) Applicant: TRIPLE WIN TECHNOLOGY ( SHENZHEN) CO. LTD., Shenzhen (CN)

(72) Inventors: YEW-KOON CHEE, New Taipei (TW); CHENG-HSING LIAO, New Taipei (TW); MING-CHUAN KUO, New Taipei (TW)

(21) Appl. No.: 19/185,496

(22) Filed: Apr. 22, 2025

(30) Foreign Application Priority Data
Nov. 15, 2024 (CN) 202411637509.7

(51) Int. Cl. F21V 8/00; G02B 1/00

(52) U.S. Cl. CPC G02B 6/0076; G02B 1/002; G02B 6/0016; G02B 6/0036; G02B 6/0068; G02B 6/0073

(57) ABSTRACT

A display apparatus includes a display comprising a first display portion configured to emit a first light beam and a second display portion configured to emit a second light beam; a meta optical structure comprising a first light-adjusting portion and a second light-adjusting portion, the first light-adjusting portion being configured to modulate a propagation direction of the first light beam, and the second light-adjusting portion being configured to modulate a propagation direction of the second light beam; a projection lens configured to receive the first light beam and the second light beam from the meta optical structure; and an optical waveguide configured to receive the first light beam and the second light beam exit from the projection lens, wherein the projection lens is configured to project the first light beam and the second light beam to the optical waveguide in different directions.

### FIELD

The subject matter herein generally relates to a display apparatus.

### BACKGROUND

A wearable display apparatus may include a display, an X-cube, an optical waveguide, etc. Color wearable display apparatus receives light beams of different wavelengths (representing different colors) and combines the light beams to generate image light. The image light undergoes multiple total reflections in the optical waveguide and are coupled to human eye to display images.

However, due to different wavelengths of the light beams in the image light, the following issues exist:
(1) light beams having different diffraction angles in the optical waveguide have different optical path lengths during each total reflection. As such, the light beams in the image light are coupled out of the optical waveguide for different times and at different positions, which can lead to uneven color ratios at different observation positions in an eye box, resulting in a “rainbow effect”; and
(2) for light beams of a same color, a diffraction efficiency of the light beams varies with different incident angles, which leads to different distribution ratios within an entire field of view (FOV) and also results in the “rainbow effect”.

### BRIEF DESCRIPTION OF THE DRAWINGS

Implementations of the present disclosure will now be described, by way of embodiment, with reference to the attached figures, wherein:

FIG. 1 shows a display apparatus according to a first embodiment of the present disclosure.

FIG. 2 shows a display apparatus according to a second embodiment of the present disclosure.

FIG. 3 shows a partition correspondence between the display and a meta optical structure shown in FIG. 2.

FIG. 4 is a planar view of an optical waveguide shown in FIG. 2.

FIG. 5 is a planar view of an embodiment of an optical waveguide according to the present disclosure.

FIG. 6 is a planar view of another embodiment of an optical waveguide according to the present disclosure.

FIG. 7 is a planar view of yet another embodiment of an optical waveguide according to the present disclosure.

FIG. 8 illustrated light paths in second embodiment of the display apparatus shown in FIG. 2.

FIG. 9 shows a display apparatus according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

“Above” means one layer is on top of another layer. In one example, it means one layer is situated directly on top of another layer. In another example, it means one layer is situated over the second layer directly or indirectly with more layers or spacers in between.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

### Embodiment 1

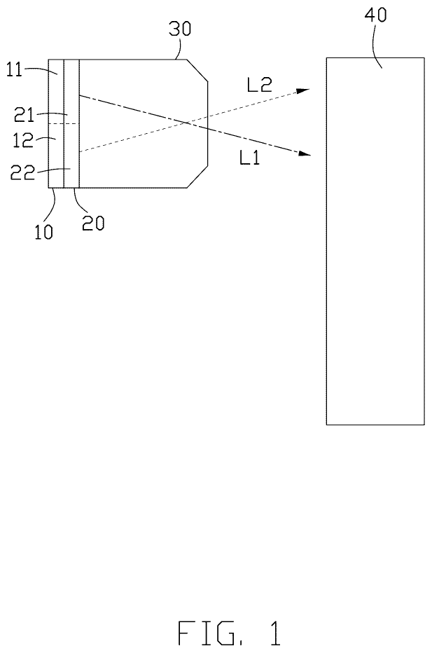

Referring to FIG. 1, a display apparatus 100 in this embodiment includes a display 10, a meta optical structure 20, a projection lens 30, and an optical waveguide 40. The display 10 is used to emit two kinds of light beams that have different wavelengths. The meta optical structure 20 is on light paths of the light beams and is used to adjust propagation directions of the light beams. The projection lens 30 is between the meta optical structure 20 and the optical waveguide 40 and is used to modulate parameters of the light beams. The two kinds of light beams exit out of the projection lens 30 in different directions. The optical waveguide 40 is used to guide the light beams to human eyes to display image.

In this embodiment, the display 10 includes a first display portion 11 and a second display portion 12 connected to each other. The first display portion 11 is configured to emit a first light beam L1 perpendicular to the first display portion 11, and the second display portion 12 is used to emit a second light beam L2 perpendicular to the second display portion 12. The first light beam L1 and the second light beam L2 have different wavelengths and different colors.

The meta optical structure 20 includes a first light-adjusting portion 21 on a light path of the first light beam L1 and a second light-adjusting portion 22 on a light path of the second light beam L2, wherein the first light-adjusting portion is connected to the second light-adjusting portion. The first light-adjusting portion 21 is used to receive the first light beam L1 from the first display portion 11 and adjust a propagation direction of the first light beam L1, the second light-adjusting portion 22 is used to receive the second light beam L2 from the second display portion 12 and adjust a propagation direction of the second light beam L2, such that the first light beam L1 and the second light beam L2 exit out of the meta optical structure 20 non-parallel.

The projection lens 30 is used to receive the first light beam L1 and the second light beam L2 from the meta optical structure 20 and modulate the parameters (such as focal length, chromatic dispersion) of the first light beam L1 and the second light beam L2. The optical waveguide 40 is used to receive the first light beam L1 and the second light beam L2 from the projection lens 30. The first light beam L1 and the second light beam L2 undergo multiple total internal reflections within the optical waveguide 40 before coupling out from it. The coupled-out first light beam L1 and second light beam L2 can then project onto the eye box region to display an image.

In this embodiment, the display apparatus 100 is used to display color images. The display apparatus 100 is used to emit the first light beam L1 and the second light beam L2 of different wavelengths (different colors), and the display apparatus 100 includes the optical waveguide 40 for guiding the first light beam L1 and the second light beam L2. The first light beam L1 and second light beam L2 of different wavelengths enter the optical waveguide 40 non-parallel (at different angles) because of the meta optical structure 20, thus a “rainbow effect” caused by a wavelength difference between the first light beam L1 and the second light beam L2 can be effectively improved.

### Embodiment 2

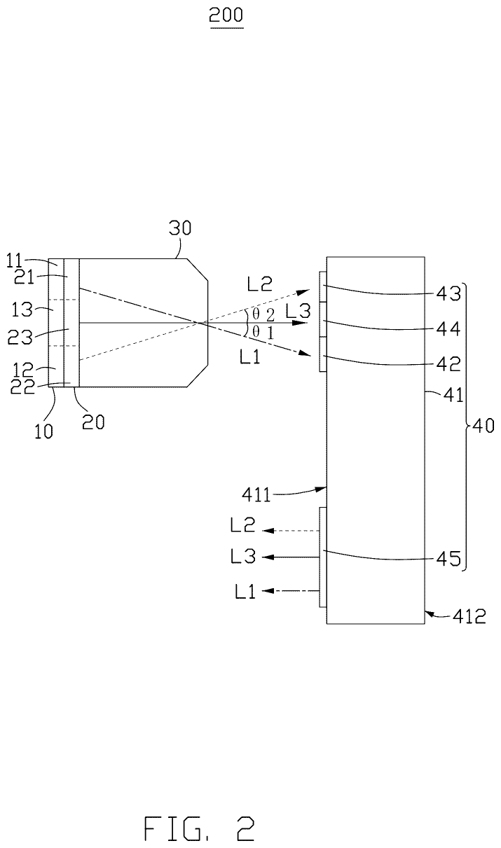

Referring to FIG. 2, a display apparatus 200 in this embodiment includes the display 10, the meta optical structure 20, the projection lens 30, and the optical waveguide 40.

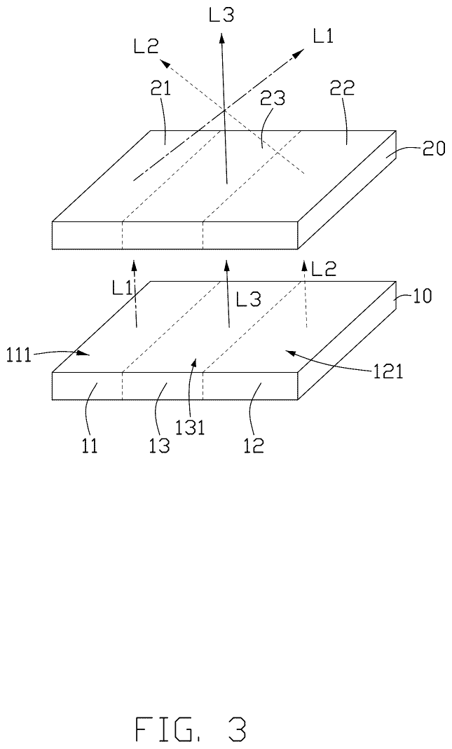

Referring to FIG. 2 and FIG. 3, the display 10 includes the first display portion 11, the second display portion 12, and a third display portion 13. The first display portion 11 has a first display surface 111 facing the meta optical structure 20, the second display portion 12 has a second display surface 121 facing the meta optical structure 20, and the third display portion 13 has a third display surface 131 facing the meta optical structure 20. The first display portion 11 is used to emit the first light beam L1 through the first display surface 111 perpendicular to the first display surface 111, the second display portion 12 is used to emit the second light beam L2 through the second display surface 121 perpendicular to the second display surface 121, and the third display portion 13 is used to emit the third light beam L3 through the third display surface 131 perpendicular to the third display surface 131. The first light beam L1, the second light beam L2, and the third light beam L3 have different wavelengths.

In this embodiment, the third display portion 13 is connected between the first display portion 11 and the second display portion 12. The first display surface 111, the second display surface 121, and the third display surface 131 are each rectangular. The first display surface 111, the second display surface 121, and the third display surface 131 are arranged side by side on a same plane, and long sides of the first display surface 111, the second display surface 121, and the third display surface 131 are connected to each other. In this embodiment, the third display surface 131 is connected between the first display surface 111 and the second display surface 121.

In other embodiments of the present disclosure, a connection order of the first display portion 11, the second display portion 12, and the third display portion 13 may be different, and shapes of the first display surface 111, the second display surface 121, and the third display surface

### 131 May Be Different.

In this embodiment, the display apparatus 200 can be a head-mounted display, an augmented reality (AR) glasses, a virtual reality (VR) glasses, or a head-up display (HUD). The wavelength of the third light beam L3 is smaller than the wavelength of the first light beam L1 and is larger than the wavelength of the second light beam L2. The third light beam L3 incident to a surface of the optical waveguide 40 perpendicular to the surface, and the first light beam L1 and the second light beam L2 are on both sides of the third light beam L3. In this embodiment, the first light beam L1 is red light, the second light beam L2 is blue light, and the third light beam L3 is green light. The display apparatus 200 can achieve full color display according to a combined light of the first light beam L1, the second light beam L2 and the third light beam L3. In other embodiments of this disclosure, the first light beam L1, the second light beam L2, and the third light beam L3 may be other colors, and colors of the first light beam L1, the second light beam L2, and the third light beam L3 are different.

In this embodiment, the first micro-display 10, the second micro-display 20, and the third micro-display 30 can be light-emitting diode (LED) displays, organic light-emitting diodes (OLED) displays, mini light-emitting diode (Mini-LED) displays, micro light-emitting diode (Micro-LED) displays, liquid crystal on silicon (LCOS) displays, etc. The first display portion 11, the second display portion 12, and the third display portion 13 may include different light emitting elements or controlled by different display method to emit light beams having different wavelengths.

The meta optical structure 20 includes the first light-adjusting portion 21 corresponding to the first display portion 11, the second light-adjusting portion 22 corresponding to the second display portion 12, and a third light-adjusting portion 23 corresponding to the third display portion 13. An orthographic projection of the first light-adjusting portion 21 on the display 10 coincides with the first display surface 111, such that the first light-adjusting portion 21 is used to receive the first light L1 from the first display surface 111 and adjust the propagation direction of the first light L1. The orthographic projection of the second light-adjusting portion 22 on the display 10 coincides with the second display surface 121, such that the second light-adjusting portion 22 is used to receive the second light L2 from the second display surface 121 and adjust the propagation direction of the second light L2. The orthographic projection of the third light-adjusting portion 23 on the display 10 coincides with the third display surface 131, such that the third light-adjusting portion 23 is used to receive the third light L3 from the third display surface 131 and adjust a propagation direction of the third light L3.

In this embodiment, the meta optical structure 20 is a metalens. The first light-adjusting portion 21, the second light-adjusting portion 22, and the third light-adjusting portion 23 are formed with different microstructures to respectively control the propagation directions of the first light beam L1, the second light beam L2, and the third light beam L3 having different wavelengths, so that the meta optical structure 20 ultimately emits the first light beam L1, the second light beam L2, and the third light beam L3 at different angles(that is, different directions) .

In this embodiment, the third light-adjusting portion 23 is connected between the first light-adjusting portion 21 and the second light-adjusting portion 22. The third light-adjusting portion 23 is used to emit the third light L3 perpendicular to the third light-adjusting portion 23, the first light-adjusting portion 21 is used to emit the first light beam L1 obliquely, and the second light-adjusting portion 22 is used to emit the second light beam L2 obliquely, too. The first light beam L1 and the second light beam L2 are on both sides of the third light beam L3, respectively. That is, the first light beam L1 and the second light beam L2 form a non-zero angle with the third light beam L3, respectively.

In other embodiments of the present disclosure, the first light-adjusting portion 21, the second light-adjusting portion 22, and the third light-adjusting portion 23 may arranged differently, however a positional relationship of the first light-adjusting portion 21, the second light-adjusting portion 22, and the third light-adjusting portion 23 is the same as that of the first display surface 111, the second display surface 121, and the third display surface 131. Therefore, the first light-adjusting portion 21 remains corresponding to the first display portion 11, the second light-adjusting portion 22 remains corresponding to the second display portion 12, and the third light-adjusting portion 23 remains corresponding to the third display portion 13.

Referring to FIG. 2, the projection lens 30 is on the light paths of the first light beam L1, the second light beam L2, and the third light beam L3. In this embodiment, the projection lens 30 may include optical elements such as lenses (or lens groups), polarizers, filters, etc., for modulating the optical parameters of the first light beam L1, the second light beam L2, and the third light beam L3. In this embodiment, the projection lens 30 receives the first light beam L1, the second light beam L2, and the third light beam L3 from the meta optical structure 20 and causes the first light beam L1, the second light beam L2, and the third light beam L3 to be emitted out of the projection lens 30 in different directions.

The optical waveguide 40 is on a side of the projection lens 30 away from the meta optical structure 20 and is used to receive the first light beam L1, the second light beam L2 and the third light beam L3 from the projection lens 30. The optical waveguide 40 is further used to couple out the first light beam L1, the second light beam L2 and the third light beam L3 for imaging. The first light beam L1, the second light beam L2 and the third light beam L3 enter the optical waveguide 40 at different angles (in directions not parallel to each other).

In this embodiment, the third light beam L3 is vertically incident to the optical waveguide 40, and the first light beam L1 and the second light beam L2 are non-vertically incident to the optical waveguide 40 and are on different sides of the third light beam L3. In this embodiment, the first light beam L1 and the second light beam L2 are symmetrically distributed on both sides of the third light beam L3. When the first light beam L1, the second light beam L2 and the third light beam L3 enter the optical waveguide 40, a first angle θ1 between the first light beam L1 and the third light beam L3 is equal to a second angle θ2 between the second light beam L2 and the third light beam L3. In other embodiments of this disclosure, when the first light beam L1, the second light beam L2 and the third light beam L3 enter the optical waveguide 40, the first angle θ1 may not be equal to the second angle θ2.

For example, in at least one embodiment of this disclosure, the first angle θ1 is less than or equal to 20° and the second angle θ2 is less than or equal to 20°. In at least one embodiment of this application, the first angle θ1 may be 5°, 10°, etc., and the second angle θ2 may also be 5°, 10°, etc. In this embodiment, the first angle θ1 and the second angle θ2 are related to wavelengths of the first light beam L1, the second light beam L2, and the third light beam L3, a refractive index of the optical waveguide 40, etc.

In the present embodiment, the optical waveguide 40 includes a single waveguide layer 41 and a first in-coupling grating 42, a second in-coupling grating 43, a third in-coupling grating 44, and an out-coupling grating 45 on a same surface of the waveguide layer 41. The first in-coupling grating 42 and the second in-coupling grating 43 are on both sides of the third in-coupling grating 44. The waveguide layer 41 includes a first surface 411 and a second surface 412 spaced apart and parallel to each other. The first surface 411 is between the projection lens 30 and the second surface 412. The first in-coupling grating 42, the second in-coupling grating 43, the third in-coupling grating 44, and the out-coupling grating 45 are spaced apart on the first surface 411.

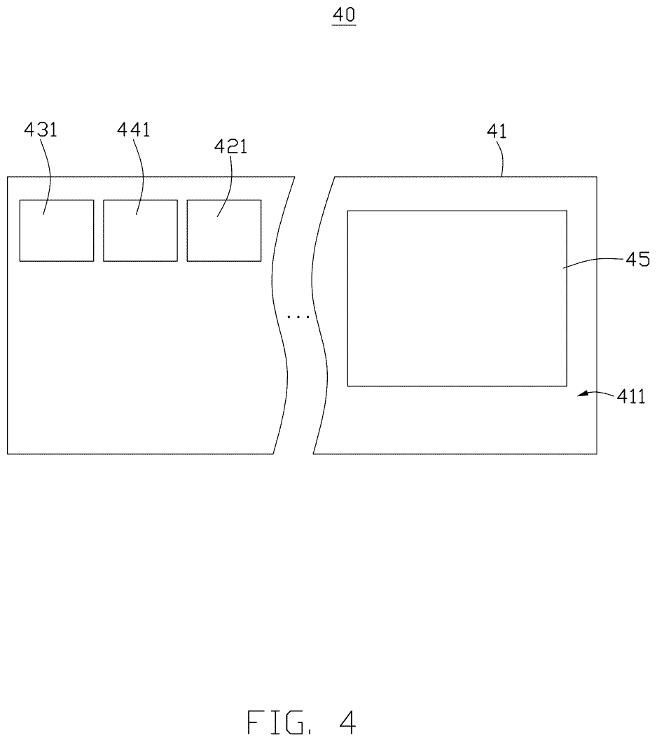

Referring to FIG. 4, in this embodiment, the first in-coupling grating 42, the second in-coupling grating 43, and the third in-coupling grating 44 are spaced apart on the first surface 411. An orthography projection of the first in-coupling grating 42 on the first surface 411 of the waveguide layer 41 is defined as a first in-coupling area 421, an orthography projection of the second in-coupling grating 43 on the first surface 411 of the waveguide layer 41 is defined as a second in-coupling area 431, and an orthographic projection of the third in-coupling grating 44 on the first surface 411 of the waveguide layer 41 is defined as a third in-coupling area 441. The first in-coupling area 421 and the second in-coupling area 431 are on both sides of the third in-coupling area 441. The first light beam L1 is not vertically incident to the first in-coupling area 421, the second light beam L2 is not vertically incident to the second in-coupling area 431, and the third light beam L3 is vertically incident to the third in-coupling area 441.

In this embodiment, the first in-coupling area 421, the second in-coupling area 431 and the third in-coupling area 441 are spaced apart from each other because the first angle θ1 and the second angle θ2 have large angle sizes, wherein the third in-coupling area 441 is between the first in-coupling area 421 and the second in-coupling area 431. The larger the angle size, the greater distances between the third in-coupling area 441 and the first in-coupling area 421 and the second in-coupling area 431.

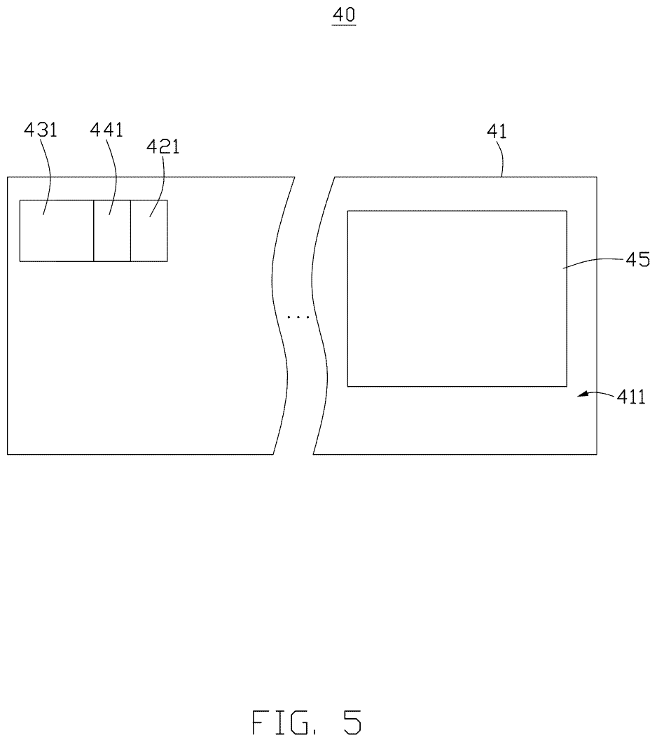

Referring to FIG. 5, in other embodiments, since the first angle θ1 and the second angle θ2 have small angle sizes, the third in-coupling area 441 may partially overlap with the first in-coupling area 421 and the second in-coupling area 431, respectively. As shown in FIG. 4, an area of the first in-coupling area 421 and an area of the second in-coupling area 431 is larger than an area of the third in-coupling area 441. The smaller the angle sizes, the larger overlapping areas of the third in-coupling area 441 and the first in-coupling area 421 and the second in-coupling area 431.

In the other embodiment, the first in-coupling grating 42, the second in-coupling grating 43, and the third in-coupling grating 44 are stacked sequentially, wherein the third in-coupling grating 44 is between the first in-coupling grating 42 and the second in-coupling grating 43. A sequence of the first in-coupling grating 42, the second in-coupling grating 43, and the third in-coupling grating 44 is not limited, and an overlapping relationship of the first in-coupling area 421, the second in-coupling area 431 and the third in-coupling area 441 is not limited, areas of the first in-coupling grating 42, the second in-coupling grating 43 and the third in-coupling grating 44 are not limited, an areas of the first in-coupling area 421, the second in-coupling area 431, and the third in-coupling area 441.

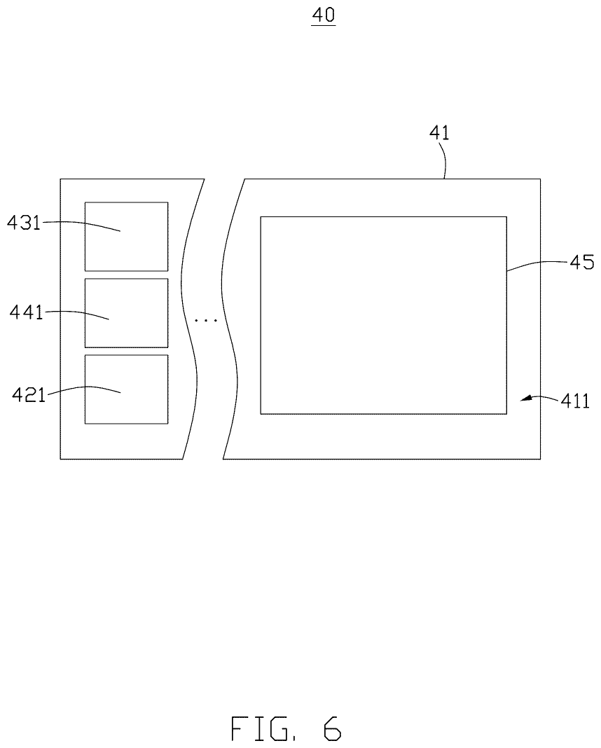

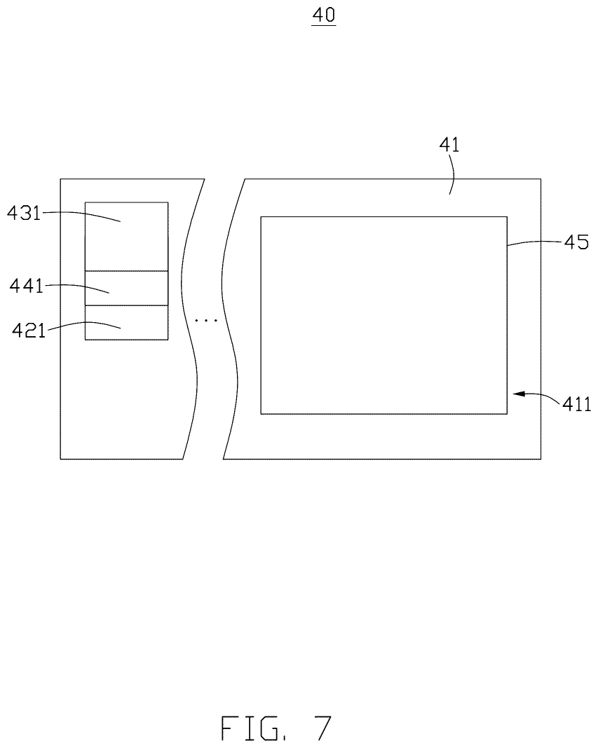

Referring to FIG. 6 and FIG. 7, in other embodiments of this disclosure, the first in-coupling grating 42, the second in-coupling grating 43 and the third in-coupling grating 44 on the waveguide layer 41 are arranged in different ways, resulting in different position relationships between the first in-coupling area 421, the second in-coupling area 431 and the third in-coupling area 441. In FIG. 5 and FIG. 4, the first in-coupling area 421, the second in-coupling area 431, and the third in-coupling area 441 are next to each other vertically instead of horizontally as shown in FIG. 3 and FIG. 4, and the first light beam L1 and second light beam L2 are distributed in on both sides (an upper side and a lower side) of the third light beam L3 in a different way from FIG. 3 and FIG. 4.

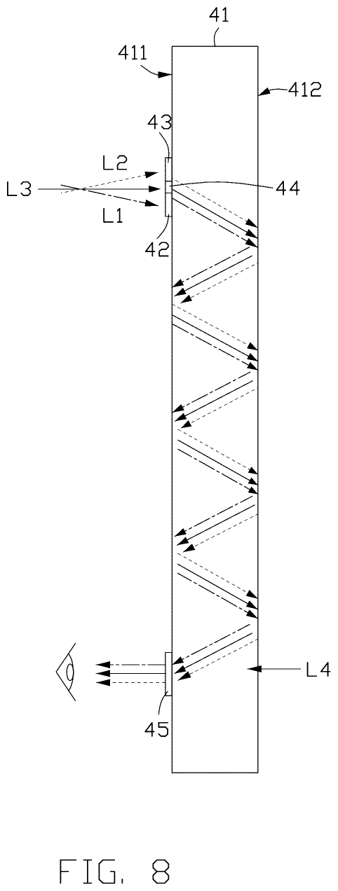

Referring to FIG. 8, in this embodiment, the three in-coupling gratings (42, 43, 44) locates at one end of the first surface 411, and the out-coupling grating 45 locates at the other end of the first surface 411. The first light beam L1, the second light beam L2, and the third light beam L3 coupled from the three in-coupling gratings coupled out from the out-coupling grating 45 after multiple total reflections in the waveguide layer 41, wherein first light beam L1, the second light beam L2, and the third light beam L3 are coupled to the user's eye box to display color images. When the display apparatus 200 is an AR glass, the waveguide layer 41 is also used to transmit ambient light L4. The ambient light L4 is transmitted from the second surface 412 to the first surface 411 and coupled out from the coupled grating 45 with the first light beam L1, the second light beam L2 and the third light beam L3, so that the human eye can simultaneously observe the images displayed by the display apparatus 200 and the real world (that is, the AR image).

In this embodiment, the display apparatus 200 includes the meta optical structure 20. To control the first light beam L1, the second light beam L2, and the third light beam L3 emit out of the projection lens 30 non-parallelly. Therefore, the first light beam L1, the second light beam L2, and the third light beam L3 are incident on the optical waveguide 40 in a non-parallel manner. Due to different wavelengths of the first light beam L1, the second light beam L2 and the third light beam L3, if the first light beam L1, the second light beam L2 and the third light beam L3 incident on the optical waveguide 40 parallel, total reflection angles of the first light beam L1, the second light beam L2 and the third light beam L3 in the optical waveguide 40 will be different, which leads to the first light beam L1, the second light beam L2 and the third light beam L3 coupling out from different positions of the optical waveguide 40 and uneven distribution of the light beams in the eye box, thereby the “rainbow effect” is caused.

Therefore, the display apparatus 200 of this embodiment can reduce differences of the total reflection angles of the first light beam L1, the second light beam L2 and the third light beam L3 in the optical waveguide 40 by making the first light beam L1, the second light beam L2 and the third light beam L3 incident on the optical waveguide 40 non-parallel. Thus, the first light beam L1, the second light beam L2, and the third light beam L3 propagate in the optical waveguide 40 tending parallel, thereby coupling the first light beam L1, the second light beam L2, and the third light beam L3 out of the optical waveguide 40 parallelly, ensuring uniform distribution of various light beam within the eye box, improving the “rainbow effect”, and enhancing a color effect of the images displayed by the display device 200.

### Embodiment 3

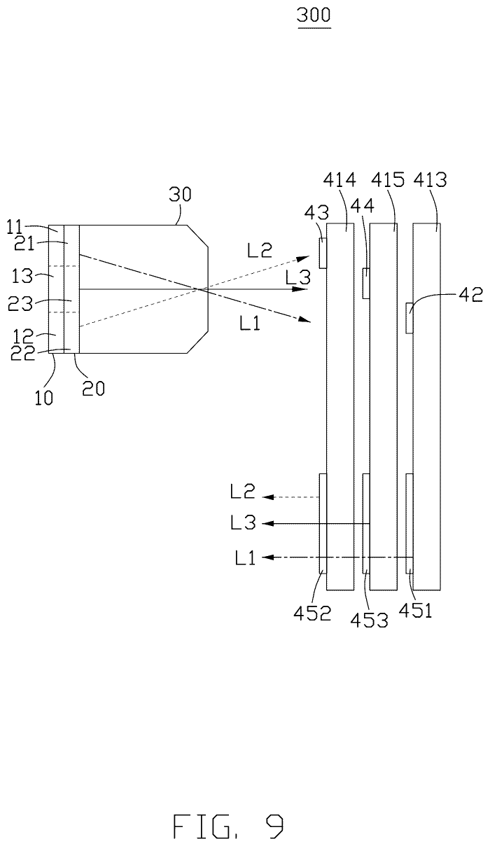

Referring to FIG. 9, a main difference between a display apparatus 300 in this embodiment and the display apparatus 100/200 in the first and second embodiment is that the structure of the optical waveguide 40.

In this embodiment, the optical waveguide 40 includes a first waveguide layer 413, a second waveguide layer 414, and a third waveguide layer 415, wherein the first waveguide layer 413, the third waveguide layer 415, and the second waveguide layer 414 are sequentially spaced apart and are parallel to each other. The first in-coupling grating 42 is on a surface of the first waveguide layer 413 towards the projected lens 50, the second in-coupling grating 43 is on a surface of the second waveguide layer 414 towards the projected lens 50, and the third in-coupling grating 44 is on a surface of the third waveguide layer 415 towards the projected lens 50.

The first light beam L1 is coupled into the first waveguide layer 413 through the first in-coupling grating 42 and is coupled out to the eye box after multiple total reflections in the first waveguide layer 413. The second light beam L2 is coupled into the second waveguide layer 414 through the second in-coupling grating 43 and is coupled out to the eye box after multiple total reflections in the second waveguide layer 414. The third light beam L3 is coupled into the third waveguide layer 415 through the third in-coupling grating 44 and is coupled out to the eye box after multiple total reflections in the third waveguide layer 415.

In this embodiment, the optical waveguide 40 also includes a first out-coupling grating 451, a second out-coupling 452, and a third out-coupling 453. The first out-coupling 451 is on the surface of the first waveguide layer 413 towards the third waveguide layer 415. The second out-coupling 452 is on the surface of the second waveguide layer 414 away from the third waveguide layer 415. The third out-coupling 453 is on the surface of the third waveguide layer 415 towards the second waveguide layer 414. Orthographic projections of the first out-coupling 451, the second out-coupling 452 and the third out-coupling 453 on the first waveguide layer 413 completely overlapping. The first out-coupling 451 is used to vertically couple the first light beam L1 out of the first waveguide layer 413, the second out-coupling 452 is used to vertically couple the second light beam L2 out of the second waveguide layer 414, the third out-coupling 453 is used to vertically couple the third light beam L3 out of the third waveguide layer 415. The first light beam L1, the second light beam L2, and the third light beam L3 are parallelly coupled out of the second coupling grating 452 to the eye box.

In this embodiment, orthographic projections of the first in-coupling grating 42, the second in-coupling grating 43, and the third in-coupling grating 44 on either waveguide layer (the first waveguide layer 413, the second waveguide layer 414, or the third waveguide layer 415) are completely overlapping. That is, the orthographic projections of the first in-coupling grating 42, the second in-coupling grating 43, and the third in-coupling grating 44 on any waveguide layer are partially overlapped or are completely separated (connected or spaced apart from each other).

The display apparatus 300 in this embodiment can achieve all the beneficial effects of the display apparatus 200 in the second embodiment. The structures of the display 10, the meta optical structure 20, and the projection lens 30 in FIG. 9 are the same as in FIG. 2. The structures of the display 10, the meta optical structure 20, and the projection lens 30 in FIG. 9 in this embodiment may be the same as described in any of the above-mentioned embodiments.

The display apparatuses (including display apparatus 100, 200, 300) in the above embodiments of this disclosure are used for displaying color images. The display apparatuses are used to transmit at least two kinds of light beams with different wavelengths, and the display apparatuses include an optical waveguide for transmitting the at least two kinds of light beams. The display apparatuses include the meta optical structure 20 having at least two light-adjusting portions to control the at least two kinds of light beams to incident on the optical waveguide in a non-parallel manner (that is, at different angles), which can compensate for total reflection angle difference caused by wavelength difference between the at least two kinds of light beams. Therefore, the total reflection angles of the at least two kinds of light beams tend to be the same when propagating in the optical waveguide. That is, the at least two kinds of light beams tend to propagate parallel in the optical waveguide, which causes color uniform when the at least two kinds of light beams coupled from the optical waveguide and can effectively improve the “rainbow effect”.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. A display apparatus comprising:
a display comprising a first display portion configured to emit a first light beam, and a second display portion configured to emit a second light beam, wherein a wavelength of the first light beam emitted by the first display portion is different from a wavelength of the second light beam emitted by the second display portion;
a meta optical structure comprising a first light-adjusting portion positioned on a light path of the first light beam, and a second light-adjusting portion positioned on a light path of the second light beam, wherein the first light-adjusting portion is configured to modulate a propagation direction of the first light beam, and the second light-adjusting portion is configured to modulate a propagation direction of the second light beam, such that the first light beam and the second light beam exit out of the meta optical structure in different directions;
a projection lens configured to receive the first light beam and the second light beam from the meta optical structure; and
an optical waveguide configured to receive the first light beam and the second light beam projected out of the projection lens, wherein the projection lens is further configured to project the first light beam and the second light beam to the optical waveguide in different directions.

2. The display apparatus according to claim 1, wherein the first light-adjusting portion and the second light-adjusting portion comprises microstructures, the microstructures of the first and the second light-adjusting portions are configured to modulate the propagation directions of the first light beam and the second light beam, respectively.

3. The display apparatus according to claim 2, wherein the first display portion comprises a first display surface configured to emit the first light beam, the second display portion comprises a second display surface configured to emit the second light beam, and the meta optical structure is connected to the first display surface and the second display surface.

4. The display apparatus according to claim 3, wherein an orthographic projection of the first light-adjusting portion on the display coincides with the first display surface, and an orthographic projection of the second light-adjusting portion on the display coincides with the second display surface.

5. The display apparatus according to claim 1, wherein the first display portion and the second display portion are adjacent to each other.

6. The display apparatus according to claim 1, wherein the meta optical structure is a metalens.

7. The display apparatus according to claim 1, wherein the optical waveguide comprises a first in-coupling grating, a second in-coupling grating, and at least one waveguide layer, the first in-coupling grating couples the first light beam into the at least one waveguide layer, and the second in-coupling grating couples the second light beam into the at least one waveguide layer; and
orthographic projections of the first in-coupling grating and the second in-coupling grating on the at least one waveguide layer are adjacent to each other.

8. The display apparatus according to claim 7, wherein the at least one waveguide layer comprises a single waveguide layer configured for transmitting the first light beam and the second light beam, and the first in-coupling grating and the second in coupling grating are on a same surface of the single waveguide layer.

9. The display apparatus according to claim 7, wherein the at least one waveguide layers comprises a first waveguide layer configured for transmitting the first light beam; and a second waveguide layer configured for transmitting the second light beam, the first waveguide layer is adjacent to the second waveguide layer, the first in-coupling grating is on the first waveguide layer, and the second in-coupling grating is on the second waveguide layer.

10. The display apparatus according to claim 1, wherein the display further comprises a third display portion configured to emit a third light beam of a wavelength different from the wavelengths of the first and the second light beams emitted by the first and the second display portions, respective;
the meta optical structure further comprises a third light-adjusting portion positioned on a light path of the third light beam and is configured to modulate a propagation direction of the third light beam, such that the first light beam, the second light beam, and the third light beam exit out of the meta optical structure in different directions; and
the projection lens is further configured to receive the first light beam, the second light beam, and the third light beam from the meta optical structure, and projects the first light beam, the second light beam, and the third light beam on the optical waveguide in different directions.

11. The display apparatus according to claim 10, wherein the optical waveguide further comprises a first in-coupling grating, a second in-coupling grating, a third in-coupling grating, and at least one waveguide layer, the first in-coupling grating receives and couples the first light beam into the at least one waveguide layer, the second in-coupling grating receives and couples the second light beam into the at least one waveguide layer, and the third in-coupling grating receives and couples the third light beam into the at least one waveguide layer; and
orthographic projections of the first in-coupling grating, the second in-coupling grating, and the third in-coupling grating on respective surfaces of the at least one waveguide layer are adjacent to each other.

12. The display apparatus according to claim 11, wherein the at least one waveguide layer comprises a single waveguide layer configured for transmitting the first light beam, the second light beam, and the third light beam, and the first in-coupling grating, the second in-coupling grating, and the third in-coupling grating are on a same surface of the single waveguide layer.

13. The display apparatus according to claim 11, wherein the at least one waveguide layers comprises a first waveguide layer configured for transmitting the first light beam, a second waveguide layer configured for transmitting the second light beam, and a third waveguide layer configured for transmitting the third light beam, the first waveguide layer, the second waveguide layer, and the third waveguide layer are sequentially stacked at intervals, the first in-coupling grating is on the first waveguide layer, the second in-coupling grating is on the second waveguide layer, and the third in-coupling grating is on the third waveguide layer.

14. The display apparatus according to claim 10, wherein a wavelength of the third light beam is shorter than a wavelength of the first light beam and is longer than a wavelength of the second light beam, and the third micro-display is further configured to emit the third light beam in a third direction vertically to the optical waveguide.

15. The display apparatus according to claim 10, wherein the wavelength of the third light beam is shorter than the wavelength of the first light beam and is longer than the wavelength of the second light beam, and the third light beam incident on the optical waveguide vertically.

16. The display apparatus according to claim 15, wherein the first light beam incidents on the optical waveguide in a first direction, the second light beam incidents on the optical waveguide in a second direction, and the third light beam incidents on the optical waveguide in a third direction; and
a first angle between the first direction and the third direction is equal to a second angle between the second direction and the third direction.

17. The display apparatus according to claim 1, wherein the optical waveguide is further configured to propagate the first light beam and the second light beam parallelly.

18. A display apparatus comprising:
a display comprising a first display portion configured to emit a first light beam, and a second display portion configured to emit a second light beam, wherein a color of the first light beam emitted by the first display portion is different from a color of the second light beam emitted by the second display portion;
a meta optical structure comprising a first light-adjusting portion positioned on a light path of the first light beam, and a second light-adjusting portion positioned on a light path of the second light beam, wherein the first light-adjusting portion is configured to modulate a propagation direction of the first light beam, and the second light-adjusting portion is configured to modulate a propagation direction of the second light beam, such that the first light beam and the second light beam exit out of the meta optical structure in different directions;
a projection lens configured to receive the first light beam and the second light beam from the meta optical structure; and
an optical waveguide configured to receive the first light beam and the second light beam projected out of the projection lens, wherein the projection lens is further configured to project the first light beam and the second light beam to the optical waveguide in different directions.
